(19) United States
(12) Patent Application Publication
(10) Pub. No.: US 2010/0146801 A1
(43) Pub. Date: Jun. 17, 2010

(54) TIGHTENING DEVICE WITH SWIVELLING HANDLING ARM AND APPLIANCE INCLUDING SUCH A DEVICE

(75) Inventor: Roger Pellenc, Pertuis (FR)

Correspondence Address: EGBERT LAW OFFICES, 412 MAIN STREET, 7TH FLOOR, HOUSTON, TX, 77002, US

(73) Assignee: Pellenc (Societe Anonyme), 84120 Pertuis (FR)

(21) Appl. No.: 12/527,666

(22) PCT Filed: Feb. 25, 2008
(86) PCT No.: PCT/FR2008/000244

§ 371 Date: Dec. 18, 2009

(30) Foreign Application Priority Data
Feb. 26, 2007 (FR) 07/01356

(51) Int. Cl. B27B 17/14; B25B 13/48; B25B 13/08

(52) U.S. Cl. 30/386; 81/177.8; 81/176.1; 81/177.2

(57) ABSTRACT

Tightening device of the screw-nut type includes a tightening member, which can be rotated, and a rotary wrench for this tightening member, equipped with a handling arm. The wrench and the tightening member are joined by a connecting device in such a way that the wrench can swivel in relation to the tightening member around a swivel axis substantially perpendicular to the screwing axis of the tightening member. Thus, it can be placed in a rest position substantially perpendicular to the screwing axis and can rotate the tightening member around the screwing axis or rotated freely in relation to the tightening member around the screwing axis, over a range of angular clearance (a) of at least 170°.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a tightening device with a swiveling arm. It also deals with the equipment provided with this tightening device, for example portable tools, and in particular portable chain saws.

2. Description of Related Art Including Information Disclosed Under 37 CFR 1.97 and 37 CFR 1.98

It is common to use a screw or a nut screwed on a threaded rod to obtain a tight grip between two parts. A part mounted by means of a screw-nut system presents the advantage of being removable. However, its disassembly and subsequent reassembly require the loosening of the nuts or the screws by means of an independent tool such as a wrench or a screwdriver, and then their re-tightening by this same tool. Now, one does not always have such a tool available, which may be lacking at the very moment when one needs to loosen and/or tighten nuts or screws.

Also, it happens frequently that a screwdriver or a wrench may slip off inadvertently from the head of the screw or from the nut during the operation. Therefore, the tightening and loosening of a nut or a screw make it sometimes necessary to know how to combine force and skill.

Portable chain saws are generally equipped with a screw-nut device to perform the tightening and blocking, in the desirable position, of the guide bar, to allow a tension adjustment of the chain or the installation of a new chain.

In such an application, one can see that the operator must always have within reach a specific tool for loosening or tightening the nut or the set screw, especially during use of the tool out of doors when one may have to perform tension adjustments of the chain saw.

To mitigate this constraint, one has proposed (DE-29909645 U1) a tightening device for the guide bar of a chain saw, by means of a screw-nut system according to which the nut of the system is permanently secured to a handling wrench which can be folded back against the tool housing, in a neutral position when not in use. According to this device, a rotary ring is placed under the head of the nut and the wrench is fastened with a capability of swiveling on this ring, around an axis that is perpendicular to the axis of the nut and in an offset manner in relation to the latter. On the other hand, two radial grooves have been made on the head of the nut, while the wrench is provided with a tooth which, depending on the swiveled position of said wrench, can mesh with one of said grooves to allow the rotary actuation of the nut in one direction or the other, or be disengaged from said grooves to let the wrench rotate freely around the nut.

This device requires, prior to the rotary movement of the nut or the placement of the wrench in the storage position, an obligatory engaging or disengaging operation, whatever the case may be, or an operation which may not be immediately understood by the users.

The aim of the invention is at least to propose a solution to the problems deriving from the various constraints exposed above.

### BRIEF SUMMARY OF THE INVENTION

According to the invention, this aim has been achieved thanks to a tightening device of the screw-nut kind, comprising a tightening member that can be rotated and a driving wrench of this tightening member equipped with a handling arm. This wrench and tightening member are joined by a connecting device contrived in such a way that the wrench can swivel in relation to the tightening member around a swivel axis that is perpendicular to the screwing axis of said tightening member, so as to allow its placement in a rest position essentially perpendicular to said screwing axis, and can rotate the tightening member around the screwing axis in the direction of tightening or of loosening, or turn freely in relation to the tightening member, around said screwing axis, over a range of angular clearance of at least 170°, after immobilization of said tightening member, at the end of the tightening operation.

Thanks to the invention, operating the tightening device does not require the use of any outside tool to tighten or loosen the tightening member (screw or nut) of said device. The wrench connected to the tightening member lets the latter rotate, even while it can be placed in a determined rest position without modifying the tight fit obtained, for example in a folded back position against the housing of the equipment so as not to interfere with the utilization of the latter. Furthermore, this operation is very simple and fast.

According to an advantageous mode of execution, the rotary tightening member of the screw-nut system joined to the handling wrench is constituted by the nut of said system.

Advantageously, the tightening member and the wrench for rotating the connecting device are equipped, respectively, with means coming into contact with each other during rotation of the wrench, on the one hand, in the screwing direction of the tightening member when the wrench is at a first end of the range of angular clearance, as well as, on the other hand, in the unscrewing direction of the tightening member when the wrench is at a second end of the range of angular clearance.

According to a preferred mode of execution, the connecting means between the wrench for rotating and the tightening member include:
a ring-shaped groove made in the outside cylindrical surface of the rotating tightening member and in the base of which is seated a catch stop which is oriented parallel to the screwing axis of said rotating tightening member;
a tubular rotating cap in which is housed the body of said tightening member and which features two diametrically opposed holes opening into the ring-shaped groove of said tightening member, and
a layout of the head of the wrench for rotating according to which said head is produced in the form of a two-pronged fork. The ends of these prongs are curved back or shaped in the direction of each other and being able to rotate in the diametrically opposed holes of the rotating cap, one at least of these bent back ends being dimensioned so it can extend through said groove and come into contact with the catch stop of the rotating tightening member.

According to another advantageous characteristic, the curved end of the second prong of the drive fork is dimensioned so as not to come into contact with the catch stop of the tightening member when the wrench is swiveled around the screwing axis, in relation to the tightening member.

Another advantageous characteristic of the tightening device can be that said connecting device produces a non-removable connection between the wrench and the tightening member.

Advantageously, the non-removable connection between the wrench and the tightening member is obtained by plastic deformation of said prongs towards each other, so as to engage these prongs in the holes of the cap.

Preferably, said connecting device forms a removable connection between the wrench and the tightening member, at least in the absence of a tightening operation by this tightening member.

Preferably, the tightening member features a notch for lateral access to said ring-shaped groove, for the passage of one of said prongs to this ring-shaped groove, one of said holes in the cap having the shape of a slot with one open end for the passage of one of said prongs.

Advantageously, the wrench has a handling arm equipped with an extension with which the handling arm forms a telescopic sleeve of variable length, said extension being movable along the handling arm between a retracted position and an extended position of the telescopic sleeve.

Preferably, one part at least of the handling arm is made of magnetic material.

The subject of the invention is also equipment characterized in that it features a tightening member as defined above.

According to an advantageous application, this equipment is constituted by a chain saw with an endless cutting chain as well as a guide bar for this chain, and where a blocking device of this guide bar includes said tightening member.

Advantageously, the equipment comprises a storage area for the sleeve of the tightening device, in a predetermined angular position, around the screwing axis.

Preferably, the equipment is provided with a magnet to retain the sleeve in the stored position in the storage area.

### BRIEF DESCRIPTION OF THE SEVERAL VIEWS OF THE DRAWINGS

The invention will be clearly understood when reading the description below, given solely as an example and made with reference to the attached drawings.

FIG. 1 is a perspective view of a chain saw in accordance with invention.

FIG. 2 is an exploded perspective view of a tightening device on the chain saw of FIG. 1, according to the invention.

FIG. 3 is a top plan view with break-away, of the tightening device of FIG. 2.

FIG. 4 is a sectional view along the line IV-IV of FIG. 3.

FIG. 5 is a sectional view along the line V-V of FIG. 3.

FIG. 6 is a perspective view of the tightening device shown in FIGS. 2 to 5, shown in its extension in the shape of a handle, illustrating a stage of assembly of the elements of said device.

FIG. 7 is a top plan view, with a partial break-away view, of the tightening device of FIGS. 2 to 5, illustrating a wrench position considered to be arbitrarily as a final stage of a tightening by means of the tightening device of FIGS. 2 to 5. The representation in thin broken lines illustrates a position of the wrench while loosening.

FIG. 8 is a perspective view analogous to FIG. 1, illustrating the same final stage of tightening as FIG. 7.

FIG. 9 is a top plan view analogous to FIG. 7, illustrating the pivoting of the wrench in a position where it can be swiveled to its retracted rest position.

FIG. 10 is a perspective view of a chain saw, showing the wrench in a swiveling position corresponding to FIG. 9.

FIG. 11 is a top plan view analogous to FIG. 9, showing the swiveling of the wrench in the rest position.

FIG. 12 is a perspective view of the chain saw shown in FIGS. 8 and 10, showing the handling arm of the wrench in the retracted position against the housing of said chain saw.

### DETAILED DESCRIPTION OF THE INVENTION

Reference is made to said drawings to describe an advantageous although by no means limiting mode of execution of the tightening device according to the invention.

Although particularly advantageous application of the invention for the equipment of chain saws is described, the claimed tightening device can also be applied to other tools or machines in which frequent tightening adjustments need to be made, especially for equipment used out of doors.

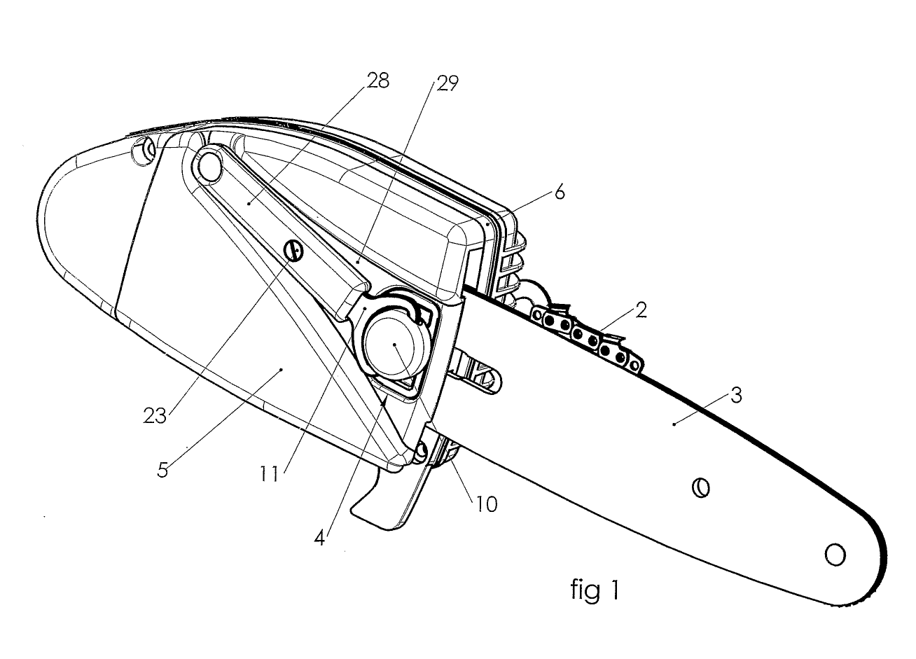

FIG. 1 shows a portable chain saw 1, which features a partially illustrated cutting chain 2 and a guide bar 3, which maintains and supports this chain 2. A tightening device 4, designated in its assembly by the reference 4 in FIG. 1, tightens this guide bar 3 and a protective housing 5 between a jaw 5A and an assembly body 6.

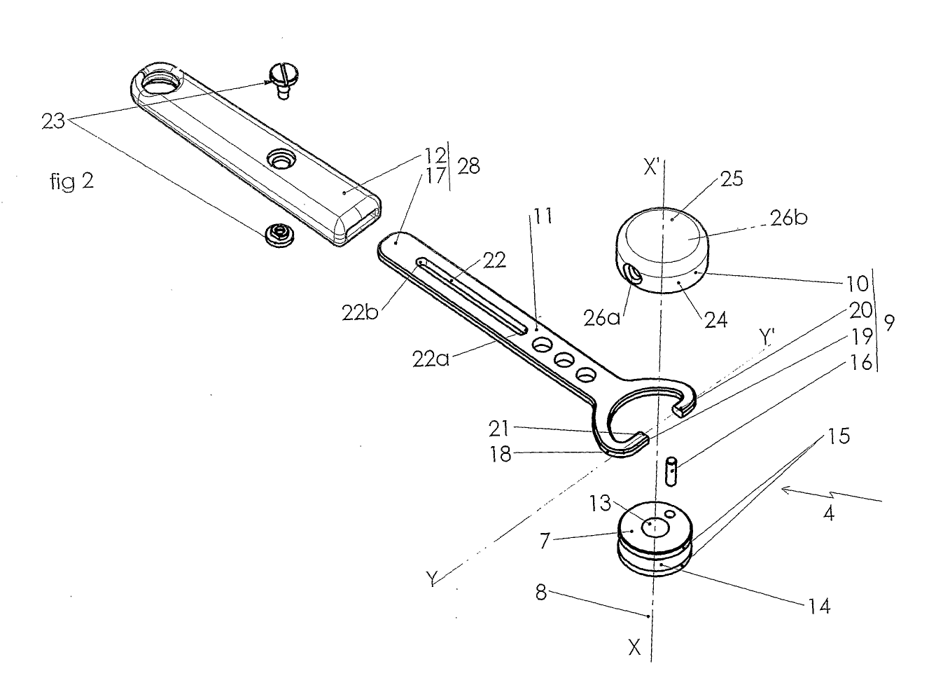

FIG. 2 shows the tightening device 4, which includes a nut 7 intended to be screwed on a threaded shank 8, for example constituted by the threaded shank of a screw. This tightening device also includes a handling wrench 11 and a connecting device designated in its entirety by the reference 9 allowing joining the nut 7 to said handling wrench 11.

The nut 7 has a tapped hole 13 with the axis X-X′ which is the screwing axis of this nut, which is to say the axis around which the nut 7 rotates, while it is being tightened and loosened. The nut 7 is provided with a ring-shaped and lateral groove 14, on its peripheral surface 15.

This peripheral surface 15 is cylindrical and has a circular section which is centered on the axis X-X′.

The nut 7 is provided with a pin 16 which traverses the lateral groove 14 all the way through.

The nut 7 is capped with a rotary encompassing tubular cap 10 featuring two diametrically opposed holes 26a, 26b going into the peripheral groove 14 of said nut.

The wrench 11 is flat and can advantageously be made from a steel blank. It comprises an arm 17, which is extended by a coupling head 18 to the nut 7. The head 18 presents the form of a fork with two prongs 19 and 20 and which bend inward towards each other. One of these prongs (prong 19) is longer than the other (prong 20) and its end portion forms a finger 21 which strikes against the pin 16, on one side or the other of the latter, depending on the rotary direction of the wrench.

The cap 10 has a cylindrical skirt 24, which is closed by an end wall 25. Two through-bores 26a and 26b for the passage of the prongs 19 and 20 are made in the skirt 24, opposite each other. One of the holes (hole 26a) can be circular and laterally closed.

According to one mode of execution, the second hole (hole 26b) presents the shape of a slot with one end being in the axis of hole 26a and the other end going into the edge of the cap 10 on the backside of the latter.

The terminal portions of the prongs 19 and 20 are co-axial and engaged in the holes 26a and 26b so as to form together a discontinued swiveling shaft of the wrench 11 on the cap 10. The swivel axis Y-Y′ of this wrench 11 is perpendicular to the screwing axis X-X′, said axes Y-Y′ and X-X′ crossing each other.

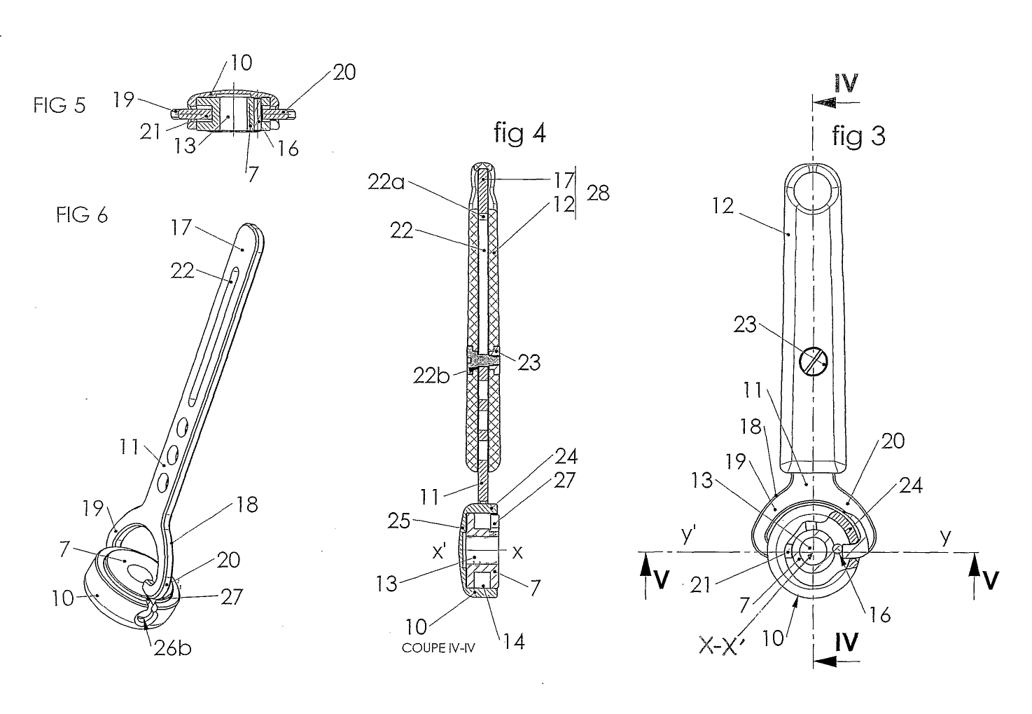

As one can see on FIGS. 3 to 5, the cap 10 is mounted in rotation on the nut 7 so that its axis of rotation coincides with the screwing axis X-X′. The prongs 19 and 20 penetrate into the peripheral groove 14 and thereby retain the wrench 11 and the cap 10 on the nut 7. Thereby they present the advantage of fulfilling a second function, their first function stated above being to form a swiveling assembly shaft.

In that respect, one notes that the prong 19, by means of its end 21, also fulfills a function of rotary catch of the nut 7. The sum of functions fulfilled by the prongs 19 and 20 contributes to an advantageous simplification of the tightening device 4 and improves it compactness.

A notch 27 is made laterally in the rear wall defining the groove 14 of the nut 7, this notch fitting into said groove.

To assemble the components of the connecting device, screw 7 is placed in the cap 10. Then the prong 19 is inserted in the hole 26a and the groove 14 of the nut. Finally, the other prong is slid towards to base of the slot 26b, while at the same time this prong 20 is engaged in the peripheral groove 14, by making it pass in the notch 27 (FIG. 6). This mode of assembly makes it possible to obtain a removable connection between the wrench 11 and the nut 7.

According to another mode of execution, the nut 7 can be without the notch 27, whereas the hole 26b can present the same circular form as the hole 26a. If this is the case, one can insert the prongs 19 and 20 in the hole 26a, the hole 26b, and the groove 14 by distorting them plastically towards each other. In this case, one obtains a non-removable connection between the wrench and the tightening member.

According to an advantageous mode of production, the handling arm of the wrench has an adjustable length. In this case, this handling arm consists of two telescopically assembled elements, namely an arm 17 equipped with the coupling head 18 on which a sliding extension 12 has been mounted.

This extension constitutes a handle, which can be produced in any convenient rigid manner, for example of plastic material. The internal arm 17 is equipped with a longitudinal slot 22 into which passes the shank of a bolt 23. This bolt 23 and the stop 22a form complementary retaining means of the handle 12 on the arm 17.

In contrast to the prong 19, the prong 20 can pass beyond the location of the pin 16 without attaching thereto, as one can see in FIG. 3.

The wrench 11 can rotate freely in relation to the nut 7, over a range of angular clearance referenced as α in FIG. 7. At one end of this range or clearance angle α, the finger 21 comes to strike against the pin 16 and thus couples the wrench 11 to the nut 7 in the direction of a screwing F1 of this nut 7, which is the case of the finger 21 shown in a solid line in FIG. 7. At the other end of the range or clearance angle α, the finger 21 also comes to strike against an opposite surface of the pin 16 and thus couples the wrench 11 to the nut 7, but in the direction of an unscrewing F2 of this nut 7, which is the case of the finger 21 of the wrench 11 in the thin broken line in FIG. 7. The pin 16 thus forms a double stop for the finger 21.

In the example shown, the range of angular clearance α extends over more than 340°, which is advantageous. It can however be less extended. But preferably, the range or angle of angular clearance α is at least 170°.

The handle 12 forms an extension in this sense that it can slide longitudinally on the arm 17. In other words, the arm 17 and the handle 12 form together a telescopic sleeve 28 which is shown in retracted position in FIG. 4 and which is shown in extension in FIG. 6.

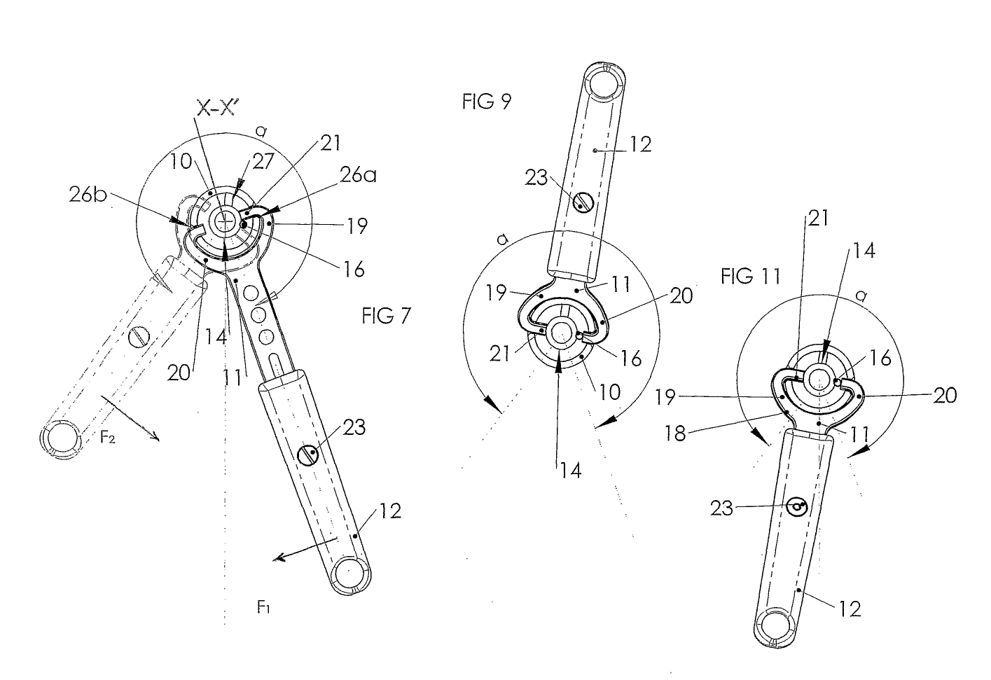

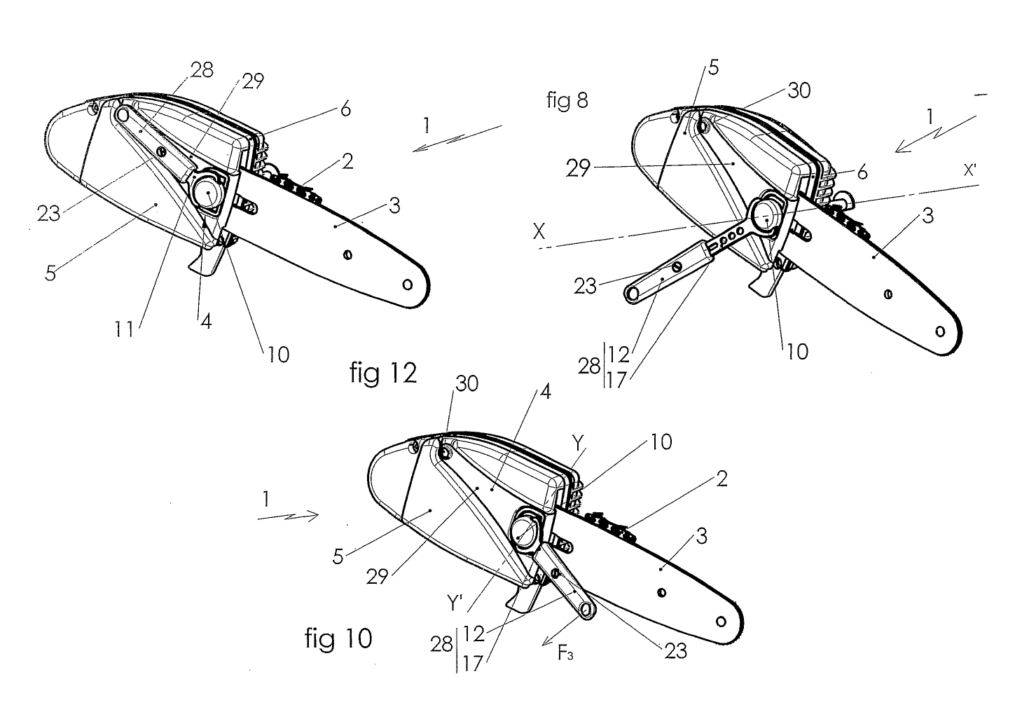

The housing 5 of the tool is laterally provided with a recess 29 to receive the handling arm 17 of the wrench or the telescopic sleeve 28 of the latter in retracted position. A retainer allows maintaining the handling arm 17 or the telescopic sleeve 28 of the wrench in the retracted position, against the housing 5 of the tool. For instance, in the base of the recess 29, a magnet is placed which retains the handling arm 17 or the sleeve 28 in the retracted resting position, this magnet being visible and designated by the reference 30 in FIGS. 8 and 10.

To tighten the nut 7, the wrench 11 is turned in the direction F1 around the screwing axis X-X′ (FIG. 7) so that its finger 21 comes into contact with the pin 16, then turns the nut 7 through the intermediary of said pin 16.

On FIGS. 7 and 8, it is assumed that the wrench 11 is in a position corresponding to the moment when the proper tightening force has just been obtained. It is then practical to retract the sleeve 28 into the recess 29 which is done without any difficulty when the angular position of this recess 29 around the axis X-X′ is within the range of angular clearance a, at the end of the tightening of the nut 7. In effect, the wrench 11 can rotate freely, with the tightening member 7 remaining blocked in the blocked position corresponding to the desired tightening.

In the example shown in FIG. 8, the angular position of the recess 29 around the axis X-X′ is outside the range of angular clearance α, after tightening of the nut 7. The storage of the sleeve 28 includes thus a first stage which consists of putting this sleeve 28 in the position shown in FIG. 10, by making it pivot around the axis X-X′, after having retracted it. On this FIG. 10, the retracted sleeve 28 is opposite the recess 29 in relation to the axis X-X′. It is then swiveled around the axis Y-Y′, in the direction of the arrow F3, in order to embed it in the recess 29, after which the sleeve 28 is as shown in FIGS. 1 and 12. In these figures, the sleeve 28 of the wrench is stored in the recess 29, where it is retained by the magnet 30 which attracts a magnetic part of this sleeve 28, namely its handling arm 17. Other means of retention of the handling arm of the wrench in the retracted position may be provided.

When the nut 7 is tightened against the jaw 5A, the latter laterally closes the notch 27, as well as the hole 26b, so that the wrench 11 and the cap 10 can no longer be separated from the nut 7.

The invention does not limit itself to the mode of production described above. In particular, the mobile tightening member in rotation can be constituted by a screw, in which case the connecting device 9, which has been described is to be found at the head of this screw.

1. Tightening device of the screw-nut type, comprising:
a tightening member being rotatable; and
a wrench rotating said tightening member and being equipped with a handling arm, said wrench and the tightening member being joined by a connecting device such that the wrench swivels in relation to the tightening member around a swivel axis perpendicular to a screwing axis of said tightening member and such that the tightening member rotates around said screwing axis, in the direction of tightening or rotates freely in relation to the tightening member around said screwing axis, over a range of angular clearance (α) of at least 170° and 240°, in an opposite direction to a tightening direction after immobilization of said tightening member, in an immobilization position, said wrench being at an end of a tightening operation, being placed in a rest position substantially perpendicular to said screwing axis.

2. Tightening device according to claim 1, wherein the tightening member comprised of a nut.

3. Tightening device according to claim 1, wherein the tightening member and the handling wrench are equipped, respectively, with means coming into contact with each other, during rotation of said wrench, in the screwing direction of the tightening member, when the wrench is at a first end of the range of angular clearance (α), and, in a loosening direction of the tightening member when the wrench is at a second end of the range of angular clearance (α).

4. Tightening device according to claim 1, wherein the connecting device between the wrench and the tightening member comprises:
a ring-shaped groove made in an external cylindrical surface of the body of the tightening member and in the base of which is placed a catch stop oriented in parallel to the screwing axis of said tightening member;
a tubular rotary cap in which is placed the body of said tightening member and featuring two diametrically opposed holes going into the ring-shaped groove of said tightening member; and
a layout of a head of the rotary wrench according to which said head is produced in the form of a fork with two prongs, the ends of these prongs being curved or shaped so as to face each other and engaged with a capability of rotating in the diametrically opposed holes of the rotary head, at least one curved ends being dimensioned to extend through said groove and come into contact of the catch stop of the tightening member, during the operation of said wrench.

5. Tightening device according to claim 4, wherein a curved end of the second prong of the fork is dimensioned so as not to come in contact with the catch stop of the tightening member during the pivoting of the wrench around the screwing axis, in relation to the tightening member.

6. Tightening member according to said claim 1, wherein the connecting device creates a non-removable connection between the wrench and the tightening member.

7. Tightening member according to claim 1, wherein the connecting device creates a removable connection between the wrench and the tightening member, at least in the absence of tightening by this tightening member.

8. Tightening device according to claim 7, wherein the tightening member comprises a notch of lateral access to said ring-shaped groove for the passage of at least one of said prongs towards this ring-shaped groove, on of said holes of the cap presenting the form of a slot having an open end for the passage of one of said prongs.

9. Tightening device according to the claim 1, wherein said wrench comprises a handling arm provided with an extension with which said handling arm forms a telescopic sleeve, said extension being movable along the handling arm between a retracted position and an extended position of the telescopic sleeve.

10. Tightening device according to claim 9, wherein said wrench comprises a stop for retaining the extension on said handling arm.

11. Tightening device according to claim 1, wherein said wrench comprises a handling arm or a sleeve, having at least a part comprised of a magnetic material.

12. Equipment, comprising:
a tightening device according to claim 1.

13. Equipment according to claim 12, being a chain saw having an endless cutting chain and a guide bar and a blocking device, comprising said tightening device to tighten said guide bar on the body.

14. Equipment according to claim 12, further comprising:
a storage area of the tightening arm or of a sleeve of the tightening device, in a predetermined angular retraction position around the screwing axis against the housing of the equipment.

15. Equipment according to claim 14, further comprising:
a magnet retaining the handling arm and of the sleeve in retracted position in the storage area.
